(19) United States
(12) Patent Application Publication
(10) Pub. No.: US 2019/0249803 A1
(43) Pub. Date: Aug. 15, 2019

(54) APPARATUS FOR SECURING A PAIR OF PIPES

(71) Applicant: David FRANKLIN, Suffolk, VA (US)

(72) Inventor: David FRANKLIN, Suffolk, VA (US)

(21) Appl. No.: 15/894,804

(22) Filed: Feb. 12, 2018

(51) Int. Cl. F16L 13/08; B23K 3/053

(52) U.S. Cl. CPC F16L 13/08; B23K 1/18; B23K 3/053

(57) ABSTRACT

An apparatus for securing a pair of pipes is disclosed. The apparatus includes a sleeve member having an inner surface and an outer surface. The inner surface of the sleeve member is adapted to conform to an exterior surface of at least one of the pair of pipes. The apparatus also includes a groove formed in the inner surface of the sleeve member. The apparatus further includes an electrical heating element disposed with the inner surface of the sleeve member such that the electrical heating element is in contact with at least one of the pair of pipes when the sleeve member is engaged therewith.

### TECHNICAL FIELD

The present disclosure relates generally to an apparatus for securing a pair of non-flat bodies together and, more particularly to, an apparatus for securing adjacent end portions of a pair of coaxial pipes in a sealing relationship.

### BACKGROUND

The common plumbing system around the world makes use of copper pipes and fittings to route supply and occasionally waste water to desired locations. Copper pipes and fittings have replaced more and more galvanized pipe in both residential and commercial plumbing and heating installations. This is because a galvanized pipe is prone to rust, and is more difficult and time-consuming to install because of the threaded joints, and the problems associated with cutting it to the precise length required. Copper pipe, on the other hand, is relatively easy and fast to cut, lightweight and flexible enough to permit a moderate amount of bending without the need for complex fittings.

Residential and commercial copper pipe plumbing systems are installed by joining the pipes using soldering techniques. For this purpose, the adjacent ends of the coaxial copper pipe and/or fitting are first prepared by polishing with steel wool or the like until all the oxides have been removed and the mating surfaces are clean and bright. Next, these surfaces are coated with flux and usually heated to a temperature above the melting point of the solder while joined together in assembled relation. Finally, the solder material is applied to the joint, which is sucked into the joint via capillary action, thereby sealing the joint.

For soldering, heat is typically applied to the joint via a flame torch. While this technique usually works well with open spaces and new construction, it is inconvenient as well as dangerous to use the flame torch in existing structures, especially in tight areas such as in-between walls and inside sink cabinets. There have been numerous reported accidents in which the technicians suffered severe burns when applying solder using a flame torch, as the open flame is always a safety hazard. The use of the flame torch for soldering purposes is also more prone to cause fire outbreak, especially when used in tight spaces, for example underneath vanity and kitchen sinks from previous plumbing repairs where shielding may not have been properly installed. It has been estimated that soldering related accidents cause millions of dollars in fire damage to homes every year. Furthermore, the use of such soldering equipment is inconvenient and cumbersome as the technician may have to hold the solder wire by one hand while applying the flame to the joint using flame torch held by another hand, thus leaving no means to adjust the connection between the pipes, if required in between the soldering process.

From the above discussion it may be understood that there are a few shortcomings of existing soldering equipment. Towards this end, there exists a need to provide a soldering device for joining a pair of copper pipes or the like, which is convenient and safe to use.

### SUMMARY

Various embodiments of the present disclosure provide a soldering device.

In one aspect, an apparatus for securing a pair of pipes is disclosed. The apparatus includes a sleeve member having an inner surface and an outer surface. The inner surface of the sleeve member is adapted to conform to an exterior surface of at least one of the pair of pipes. The apparatus also includes a groove formed in the inner surface of the sleeve member. The apparatus further includes an electrical heating element disposed with the inner surface of the sleeve member such that the electrical heating element is in contact with at least one of the pair of pipes when the sleeve member is engaged therewith.

In another aspect, an apparatus for securing adjacent end portions of a pair of coaxial pipes at a joint in a sealing relationship is disclosed. The apparatus includes a sleeve member having an inner surface and outer surface. The sleeve member comprises a first half and a second half articulately coupled to each other via a hinge joint to allow the sleeve member to move between an open position and a closed position. The inner surface of the sleeve member is adapted to conform to an exterior surface of at least one of the pair of coaxial pipes. The apparatus also includes a groove formed proximal to a first axial end in the inner surface of the sleeve member. The groove is adapted to accommodate a length of solder wire therein. The apparatus further includes an electrical heating element disposed proximal to a second axial end with the inner surface of the sleeve member such that the electrical heating element is in contact with at least one of the pair of coaxial pipes when the sleeve member is engaged therewith. In the apparatus, the sleeve member is engaged with the pair of coaxial pipes in the closed position such that the groove is disposed substantially over the joint therebetween. Further, in the apparatus, the electrical heating element generates heat to melt the solder wire to be sucked into the joint, thereby sealing the joint.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 is a front perspective view of an apparatus for securing a pair of pipes in a closed position, in accordance with an example embodiment of the present disclosure;

FIG. 2 is a side perspective view of the apparatus of FIG. 1 in the closed position, in accordance with an example embodiment of the present disclosure;

FIG. 3 is a front perspective view of the apparatus of FIG. 1 in an open position, in accordance with an example embodiment of the present disclosure;

FIG. 4 is a rear perspective view of the apparatus of FIG. 1 in the open position, in accordance with an example embodiment of the present disclosure;

FIG. 5 is a front perspective view of the apparatus of FIG. 1 in the open position with a solder wire accommodated therein, in accordance with an example embodiment of the present disclosure; and

FIG. 6 is a front perspective view of the apparatus of FIG. 1 for securing a pair of pipes in the open position with a solder wire accommodated therein, in accordance with another example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

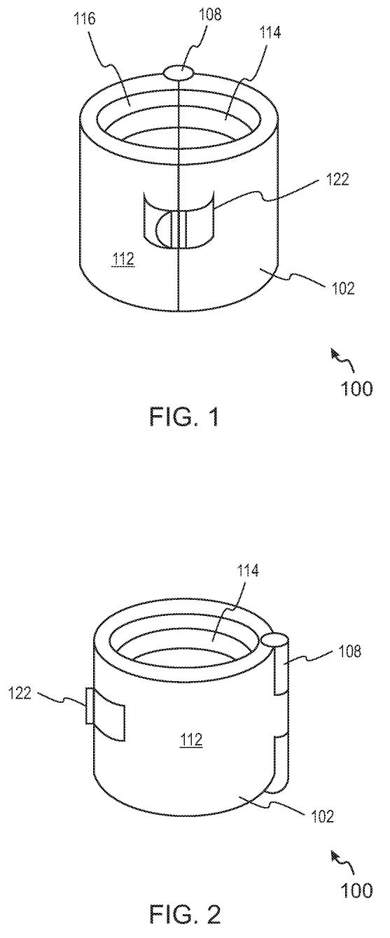

Referring to the drawings, FIG. 1 illustrates a perspective view of an apparatus (generally designated by the numeral 100) for securing a pair of non-flat components. In particular, the apparatus 100 is configured for securing a pair of pipes in a sealing relationship. The apparatus 100 is specifically designed for soldering adjacent end portions of a pair of coaxial pipes. Hereinafter, the term “apparatus 100” has been interchangeably used with the term “soldering device 100,” without any limitations. In general, the soldering device 100 may be used for soldering copper pipes and fittings in any desired relationship, for example, but not limited to, a pair of coaxial copper pipes, a copper pipe with a copper fitting, such as a tee-fitting, or the like. Further, the soldering device 100 is designed to provide any type of desired joint between the two non-flat components, including the commonly used sweated joint between the pair of copper pipes and/or fittings.

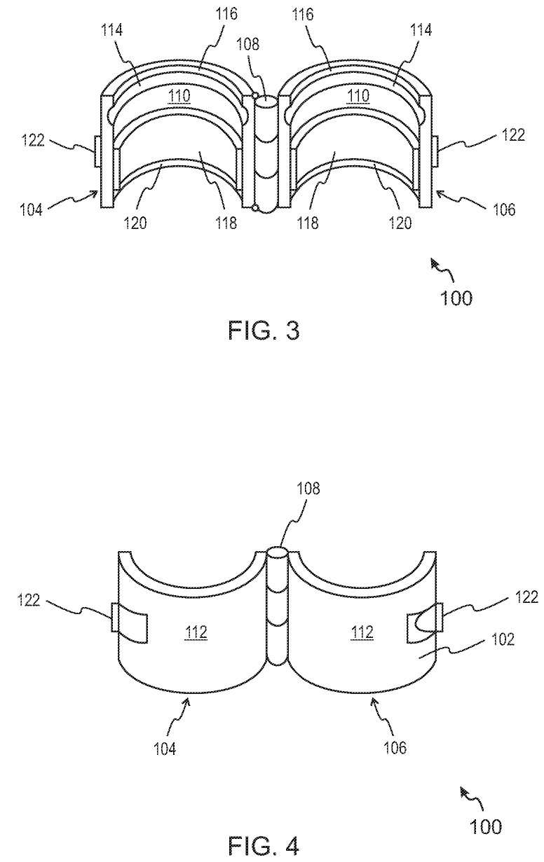

As illustrated in FIGS. 1-2, the soldering device 100 includes a sleeve member 102. The sleeve member 102 has a substantially hollow cylindrical structure with a bore extending along an axial direction thereof. In one embodiment, as illustrated better in FIGS. 3-4, the sleeve member 102 has a split configuration. In such case, the sleeve member 102 includes a first half 104 and a second half 106 articulately coupled to each other. As illustrated, the first half 104 and the second half 106 may be coupled to each other via a hinge joint 108. This allows the sleeve member 102 to be disposed and move between an open position (as illustrated in FIGS. 1-2) and a closed position (as illustrated in FIGS. 3-4). It may be contemplated by a person skilled in the art that such split configuration may allow the sleeve member 102 to collapsibly engage with a cylindrical surface, such as that of a pipe or the like. In some examples, the hinge joint 108 may be spring loaded such that the sleeve member 102 is urged to the closed position into engagement with at least one of the pair of coaxial pipes, which needs to be secured together using the soldering device 100 of the present disclosure.

As illustrated, the sleeve member 102 has an inner surface 110 and an outer surface 112. In order to properly engage with the non-flat components, the sleeve member 102 may have a non-flat inner surface 110. For example, for engaging with the typical cylindrical pipes, the sleeve member 102 may have a substantially cylindrical inner surface 110. This allows the inner surface 110 of the sleeve member 102 to conform to an exterior surface of the pipe to which the soldering device 100 needs to be engaged. Further, the outer surface 112 of the sleeve member 102 may generally have a similar cylindrical shape such as that of the inner surface 110; however, in some examples, the outer surface 112 may have any other suitable shape without any limitations. The sleeve member 102 may generally have dimensions such that an internal diameter of the sleeve member 102 is substantially equal to a nominal diameter of the pipe or the like to which the soldering device 100 may be engaged with. In some examples, the sleeve member 102 may be custom designed to have dimensions to allow for the soldering device 100 to snugly fit over a desired component, such as the copper pipe.

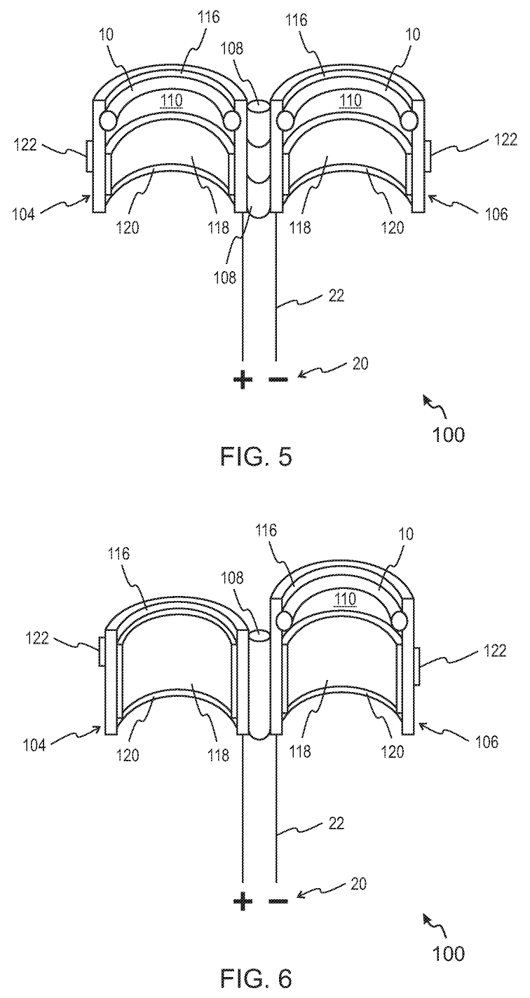

According to an embodiment of the present disclosure, the soldering device 100 includes a groove 114 formed in the inner surface 110 of the sleeve member 102. The groove 114 may generally be formed proximal to a first axial end 116 of the sleeve member 102. In one example, as illustrated in FIG. 3, the groove 114 may extend along circumferential length of the inner surface 110 of the sleeve member 102. As illustrated in FIG. 3, the groove 114 may be split in two portions, with the two portions independently extending between the first half 104 and the second half 106 of the sleeve member 102. In other examples, the groove 114 extends along at least a portion of circumferential length of the inner surface 110 of the sleeve member 102 (as illustrated in FIG. 6); for example, in case of need of providing a seal joint only to a portion of the circumference of the pipe. In an embodiment, the groove 114 has a semi-circular shape (or in other words, half-circular shape) so as to accommodate a length of solder wire 10 therein. The groove 114 may generally have a diameter substantially equal to a nominal diameter of the solder wire 10, so that the solder wire 10 may properly be placed inside therein (as illustrated in FIG. 5 and FIG. 6). In one example, the groove 114 may have a diameter in the range of 0.118-125 inch to allow an interference fit with typical solder wire as available in hardware stores.

Further, in an embodiment, the soldering device 100 of the present disclosure includes an electrical heating element 118. As illustrated in FIG. 3, the electrical heating element 118 is provided along the inner surface 110 of the sleeve member 102. In the illustrated examples, the electrical heating element 118 is disposed proximal to a second axial end 120 of the sleeve member 102. It may be seen that the electrical heating element 118 may be divided into two parts, the two parts being respectively disposed with the first half 104 and the second half 106 of the sleeve member 102 having the split configuration. It may be understood that the electrical heating element 118 is provided along the inner surface 110 such that the electrical heating element 118 is in contact with at least one of the pair of coaxial pipes when the sleeve member 102 is engaged therewith.

For the purposes of the present disclosure, the electrical heating element 118 may basically be an electric resistance based heater which converts electric energy into heat energy. The amount of heat generated by the electrical heating element 118 may be varied by varying the resistance thereof. In an embodiment, the electrical heating element 118 is a band heater. Such band heaters are well known in the art and thus have not been described in detail herein for the brevity of the present disclosure. As may be seen a thin, hinged band heater may be epoxied into the sleeve member 102 at the second axial end 120 therein to provide the heat required to the joint fitting to melt the solder wire 10 placed in the groove 114 at the first axial end 116 of the sleeve member 102. In one example, the two-piece electrical heating element 118 is roughly 0.125 inch in thickness and 0.5 inch in width, and may radially cover the inner surface 110 of the sleeve member 102. In general, the electrical heating element 118 may be connected to a power source 20, such as a power outlet, to receive electric energy. For this purpose, the electrical heating element 118 may include connection ports (not illustrated) which may allow a lead wire 22 to be connected thereto from one end, and the other end of the lead wire 22 may be connected to the power source 20 (as schematically shown in FIG. 5 and FIG. 6). Typically, the power source 20 may be a standard 115V RMS receptacle outlet. In alternate examples, the soldering device 100 may be provided with a battery power source, for example, a high energy density capacitors or the like, to make the whole apparatus 100 further more portable to use.

Further, in an embodiment, the soldering device 100 may include a locking member 122 provided at the outer surface 112 of the sleeve member 102. The locking member 122 is configured to clamp the first half 104 and the second half 106 of the sleeve member 102, such that the soldering device 100 is locked and disposed in the closed position. The locking member 122 may be any suitable locking mechanism for this purpose. For example, the locking member 122 may be a toggle clamp as widely known in the art, which generally includes a clamp belt or the like which may encircle the outer surface 112 of the sleeve member 102 to be wedged back into a loop or the like. In some examples, the locking member 122 may also provide a tightening mechanism (not illustrated) to firmly lock the first half 104 and the second half 106 with each other so that the sleeve member 102 snugly fits over the pipe or the like.

It may be contemplated by a person skilled in the art that when the soldering device 100 is engaged with a pipe or the like and the electric energy is supplied to the electrical heating element 118, the electrical heating element 118 may generate heat energy to heat up a female side of the pipe fitting, which in turn may heat up the solder wire 10 seated in the groove 114 of the sleeve member 102 and in contact therewith to its melting temperature. Solder is a metallic alloy with a respectively low melting temperature, typically between 420-460° F.; thus, the electrical heating element 118 may be configured to generate enough heat energy to heat up the solder wire 10 placed in the groove 114 to its melting temperature. In one embodiment, the electrical heating element 118 has a variable operating temperature in the range of between 500-1000° F. It may further be contemplated that when the soldering device 100 is implemented for soldering adjacent portions of a pair of coaxial pipes, the inner surface 110 of the sleeve member 102 is engaged with the exterior surface of at least one of the pair of coaxial pipes such that the groove 114 may lie directly above a joint between the adjacent portions of the pair of coaxial pipes in order for the melted solder flux material to be drawn into the joint via capillary action. This results in sealing of the joint which thereby secure the pair of pipes with each other.

In an embodiment, the sleeve member 102 is made of electrically non-conductive material. Further, the sleeve member 102 is made of heat resistant material, i.e. thermally non-conductive material. In one or more examples, the sleeve member 102 may be made of ceramic material. It may be contemplated that the sleeve member 102 is made of non-conductive materials so that the heat generated by the electrical heating element 118 is localized within the inner surface 110 and is not conducted to the outer surface 112 of the sleeve member 102 which is sometimes handled by a user, thereby avoiding any possible burn injury to the user. In one or more embodiments, the sleeve member 102 may be manufactured by casting process or the like. The sleeve member 102 may generally be designed to have enough thickness to provide sufficient thermal resistance for handling the soldering device 100 without the risk of burning or damaging the surrounding structures, yet the thickness of the sleeve member 102 may be such that the soldering device 100 is compact enough to fit between a majority of pipe sections with quick turns.

It may be understood that process of prepping the joint for the present soldering device 100 is the same as used during conventional flame soldering. Flux is still applied to the disassembled joint and the joint is then temporarily made up. That is, the adjoining portions of the pipe and fitting are first polished with steel wool or the like until all the oxides have been removed and the mating surfaces are clean and bright. The advantage of the present soldering device 100 is that during final makeup of the joint, instead of heating a joint with a torch and applying solder, the user may simply cut two require length strips of the solder wire 10 from the available roll, place the stripes in the portions of the groove 114 of the soldering device 100 (as illustrated in FIGS. 5-6), and clamp the sleeve member 102 around the joint seam at the correct location with the groove 114 directly above the joint seam. When the soldering device 100 is switched on, the electrical heating element 118 may shortly after begin to heat up the pipe and the corresponding joint enough to melt the solder material (solder wire 10), yet stay well below the melting point of copper pipe which is approximately 2000° F. The melted solder will then be drawn or sucked into the joint via capillary action, thus securely sealing the copper pipes together. It may be understood that the soldering device 100 of FIG. 6 allows for inspection of the formed seal joint without the need of removal thereof. Further, the soldering device 100 of FIG. 6 allows for manual addition of solder wire 10 if necessary.

Embodiments of the present disclosure substantially eliminate or at least partially address the aforementioned problems in the background, and provide an improved apparatus 100 for securing a pair of pipes. The soldering device 100 of the present disclosure provides a safe and more convenient alternative to flame-soldering technique for pipe fittings. While the conventional soldering techniques are inconvenient and dangerous, the soldering device 100 of the present disclosure allows both novice homeowners and professionals to join copper pipes quickly, easily, and in a safe manner. The present soldering device 100 being compact may easily be utilized for plumbing installations in tight spaces. The soldering device 100 may also provide convenience as the technician can handle the apparatus 100 with one hand only as compared to using flame torch which needs to be handled using both hands, thus leaving the other hand free to allow the technician to adjust the pipes or fitting for proper sealing, if required. Furthermore, the use of a conventional torch flame to heat up the joint has certain disadvantages. For example, in certain installations, the joint lies in close proximity to floor joists, studs and walls which became scorched by an open flame due to the difficulty in controlling the latter. Since, the present soldering device 100 uses electric resistance to generate localized heat around the joint seam, there is no flame and this no risk of damaging the surrounding structures, while also mitigating the risk of causing fire and possible damages therefrom.

The embodiments illustrated and described herein as well as embodiments not specifically described herein but within the scope of aspects of the invention constitute exemplary soldering device 100.

The benefits and advantages described above may relate to one embodiment or may relate to several embodiments. The embodiments are not limited to those that solve any or all of the stated problems or those that have any or all of the stated benefits and advantages.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

What is claimed is:

1. An apparatus for securing a pair of pipes, comprising:
a sleeve member having an inner surface and an outer surface, wherein the inner surface of the sleeve member is adapted to conform to an exterior surface of at least one of the pair of pipes;
a groove formed in the inner surface of the sleeve member; and
an electrical heating element disposed within the inner surface of the sleeve member such that the electrical heating element is in contact with at least one of the pair of pipes when the sleeve member is engaged therewith.

2. The apparatus as claimed in claim 1, wherein the groove is formed proximal to a first axial end of the inner surface of the sleeve member and the electrical heating element is disposed proximal to a second axial end of the inner surface of the sleeve member.

3. The apparatus as claimed in claim 1, wherein the sleeve member has a substantially cylindrical inner surface.

4. The apparatus as claimed in claim 3, wherein the groove extends along circumferential length of the inner surface of the sleeve member.

5. The apparatus as claimed in claim 3, wherein the groove extends along at least a portion of circumferential length of the inner surface of the sleeve member.

6. The apparatus as claimed in claim 1, wherein the sleeve member comprises a first half and a second half articulately coupled to each other via a hinge joint to allow the sleeve member to move between an open position and a closed position.

7. The apparatus as claimed in claim 6 further comprising a locking member provided at the outer surface of the sleeve member, the locking member configured to clamp the first half and the second half together to dispose the sleeve member in the closed position.

8. The apparatus as claimed in claim 6, wherein the hinge joint is spring loaded such that the sleeve member is urged to the closed position into engagement with at least one of the pair of pipes.

9. The apparatus as claimed in claim 1, wherein the groove is of semi-circular shape and adapted to accommodate a length of solder wire therein.

10. The apparatus as claimed in claim 9, wherein the groove has a diameter substantially equal to a nominal diameter of the solder wire.

11. The apparatus as claimed in claim 1, wherein the electrical heating element is a band heater.

12. The apparatus as claimed in claim 1, wherein the electrical heating element has a variable operating temperature between 500-1000° F.

13. The apparatus as claimed in claim 1, wherein the sleeve member is made of electrically non-conductive material.

14. The apparatus as claimed in claim 1, wherein the sleeve member is made of heat resistant material.

15. An apparatus for securing adjacent end portions of a pair of coaxial pipes at a joint in a sealing relationship, comprising:
a sleeve member having an inner surface and an outer surface, and comprising a first half and a second half articulately coupled to each other via a hinge joint to allow the sleeve member to move between an open position and a closed position, wherein the inner surface of the sleeve member is adapted to conform to an exterior surface of at least one of the pair of coaxial pipes;
a groove formed proximal to a first axial end in the inner surface of the sleeve member, wherein the groove is adapted to accommodate a length of solder wire therein; and
an electrical heating element disposed proximal to a second axial end with the inner surface of the sleeve member such that the electrical heating element is in contact with at least one of the pair of coaxial pipes when the sleeve member is engaged therewith, wherein
the sleeve member is engaged with the pair of coaxial pipes in the closed position such that the groove is disposed substantially over the joint therebetween,
the electrical heating element generates heat to melt the solder wire to be sucked into the joint, thereby sealing the joint.

16. The apparatus as claimed in claim 15, wherein the sleeve member has a substantially cylindrical inner surface.

17. The apparatus as claimed in claim 16, wherein the groove extends along circumferential length of the inner surface of the sleeve member.

18. The apparatus as claimed in claim 15 further comprising a locking member provided at the outer surface of the sleeve member, the locking member configured to clamp the first half and the second half together to dispose the sleeve member in the closed position.

19. The apparatus as claimed in claim 15, wherein the hinge joint is spring loaded such that the sleeve member is urged to the closed position into engagement with at least one of the pair of coaxial pipes.

20. The apparatus as claimed in claim 15, wherein the groove is of semi-circular shape and has a diameter substantially equal to a nominal diameter of the solder wire.
